(19) United States
(12) Patent Application Publication
(10) Pub. No.: US 2015/0263869 A1
(43) Pub. Date: Sep. 17, 2015

(54) SYSTEMS AND METHOD FOR FINITE RATE OF INNOVATION CHANNEL ESTIMATION

(71) Applicant: QUALCOMM Incorporated, San Diego, CA (US)

(72) Inventors: Roy Franklin Quick, JR., San Diego, CA (US); Farrokh Abrishamkar, San Diego, CA (US); Ori Shental, Tzur Yigal (IL); Marvin Leroy Vis, Boulder, CO (US); Ali Hormati, Chavannes-pres-Renens (CH); Roland Rick, Superior, CO (US)

(73) Assignee: QUALCOMM Incorporated, San Diego, CA (US)

(21) Appl. No.: 14/207,283

(22) Filed: Mar. 12, 2014

(51) Int. Cl. H04L 25/02; H04B 1/7097; H04B 1/707; H04B 1/7073

(52) U.S. Cl. CPC H04L 25/0202; H04B 1/7073; H04B 1/7097; H04B 1/707

(57) ABSTRACT

This disclosure provides systems, methods and apparatus for finite rate of innovation channel estimation. In one aspect an apparatus for equalizing received signals is provided. The apparatus comprises a signal per-processing unit configured to process received pilot signals transmitted through a sparse channel into at least one composite signal. The at least one composite signal further includes a plurality of signal peaks. The apparatus further comprises a Fourier transform unit configured to transform the at least one composite signal into frequency-domain data and a channel estimation unit configured to estimate at least one delay value and at least one peak value from the frequency-domain data.

### FIELD

The present disclosure relates generally to channel parameter estimation for a wireless communication system. More particularly, it relates to implementations of methods and systems that may achieve higher overall throughput and improve communication efficiency via finite rate of innovation channel parameter estimation for a CDMA communication system.

### BACKGROUND

In a communication system, e.g., a code-division multiple access (CDMA) system, a Rake receiver may be used for separating multipath propagated signal components after reception and before combining the multipath propagated signal components for decoding. In general, the signal components are then separated from each other at least by using a part of a spreading code of a pilot signal. The Rake receiver comprises Rake fingers where despreading and diversity combination take place. In addition, the received signal may also include, in addition to the desired signal, noise and interference caused by other users or systems. In systems utilizing diversity, the influence of multipath signals, noise and interference can be decreased by using a diversity combining technique and/or an equalizer.

In the conventional Rake receiver, the combining of the multipath signals can be accomplished by using different diversity combining techniques, in addition to a maximum ratio combining (MRC) method, such as by using equal gain combining and signal-to-interference ratio (SIR) combining. The end result is an indication of how multipath signals are weighted before summing. Of these methods, SIR combining is typically preferred since it gives the best performance. However, SIR combining is significantly more complex than other approaches, resulting in sub-optimal methods, such as MRC, being used for practical reasons.

One challenge to the use of a MRC Rake is that under certain conditions it can result in performance that is less than what would be expected. If a RAKE receiver or an equalizer cannot properly detect a delay value and a relative peak value of a multipath signal component, a RAKE finger may be allocated to a time instant where there in reality is no desired signal, the finger will add interference only to the combined signal and finally decrease the performance of a receiver.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

In one aspect an apparatus for equalizing received signals is provided. The apparatus comprises a signal processing unit configured to process received pilot signals transmitted through a wireless channel into at least one composite signal. The apparatus further comprises a Fourier transform unit configured to transform the at least one composite signal into frequency-domain data and estimate at least one delay value of the wireless channel from the frequency-domain data.

Another aspect provides a method of equalizing received signals. The method comprises processing received pilot signals transmitted through a wireless channel into at least one composite signal, transforming the at least one composite signal into frequency-domain data, and estimating at least one delay value from the frequency-domain data.

Another aspect provides an apparatus for equalizing received signals. The apparatus comprises means for wirelessly receiving signals, and means for processing received pilot signals into at least one composite signal. The apparatus further comprises means for estimating at least one delay value and at least one peak value from the composite signal.

In another aspect, a non-transient computer readable media is provided having instructions stored thereon that cause a wireless communication apparatus to perform the method of processing received pilot signals transmitted through a wireless channel into at least one composite signal, transforming the at least one composite signal into frequency-domain data, and estimating at least one delay value from the frequency-domain data.

### BRIEF DESCRIPTION OF THE DRAWINGS

FIG. 1 is a diagram of an exemplary wireless communication system including a sparse channel.

FIG. 2 is a block diagram of an exemplary wireless communication device which may be used in the system of FIG. 1.

FIG. 3A is a schematic diagram of a WCDMA transmitter circuit.

FIG. 3B is a schematic diagram of exemplary components of channel estimation in a WCDMA receiver in accordance with one embodiment.

FIG. 4 is a flow chart showing an exemplary method of channel estimation in accordance with one embodiment.

FIGS. 5A and 5B are flow charts showing exemplary finite rate of innovation channel estimation.

FIGS. 6A and 6B are flow charts of exemplary finite rate of innovation channel estimation, in accordance with exemplary embodiments of the invention.

FIG. 7 is another flow chart showing exemplary finite rate of innovation channel estimation, in accordance with an exemplary embodiment of the invention.

FIG. 8 is a flow chart of exemplary finite rate of innovation channel estimation, in accordance with an exemplary embodiment of the invention.

FIG. 9 s a flow chart of exemplary finite rate of innovation channel estimation, in accordance with an exemplary embodiment of the invention.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

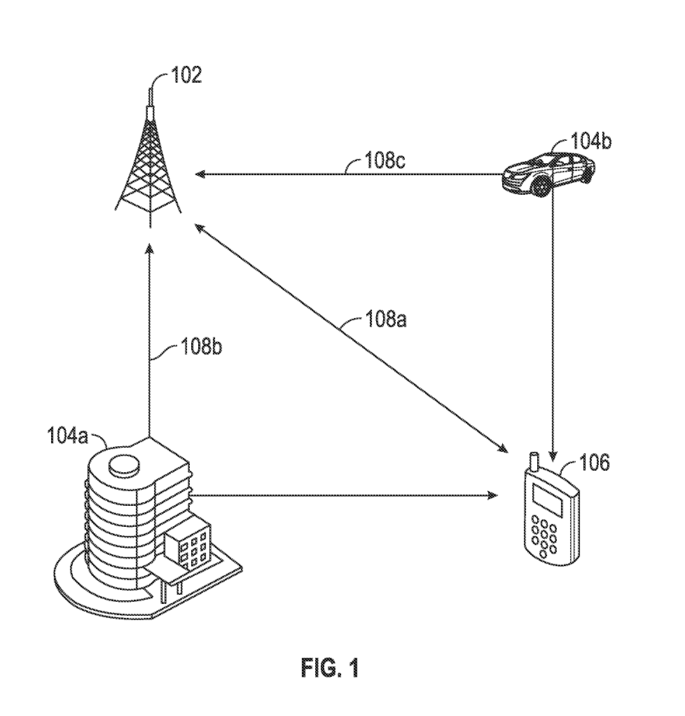

FIG. 1 illustrates a wireless communication system in which the systems and methods described herein may be implemented. The system includes a first transmitter/receiver 102 and a second transmitter/receiver 106. Each is configured to receive wireless signals from the other. The communication channel of FIG. 1 between the two devices 102 and 106 comprises multiple paths for signal travel between the first transmitter/receiver 102 and the second transmitter/receiver 106. These paths may include a direct path 108a as well as additional paths denoted 108b and 108c which are reflected off of objects or other reflecting features denoted 104a and 104b in the vicinity of the two devices 102 and 106. Due to the multiple paths, a receiving device will receive multiple copies of the transmitted signal, with each copy associated with a signal strength, a phase rotation, and a timing delay. A channel with these characteristics is known as a “sparse” channel, and each separate path is known as a “channel tap,” where the term “sparse” generally refers to channels having a relatively small number of channel taps relative to the time index of the most delayed tap. The systems and methods used herein may be used with channels of widely varying sparsity, including, but not limited to, channels of less than 20% tap occupation percentage, or less than 10% tap occupation percentage. Wireless communication channels with these properties are very common in wireless communication systems.

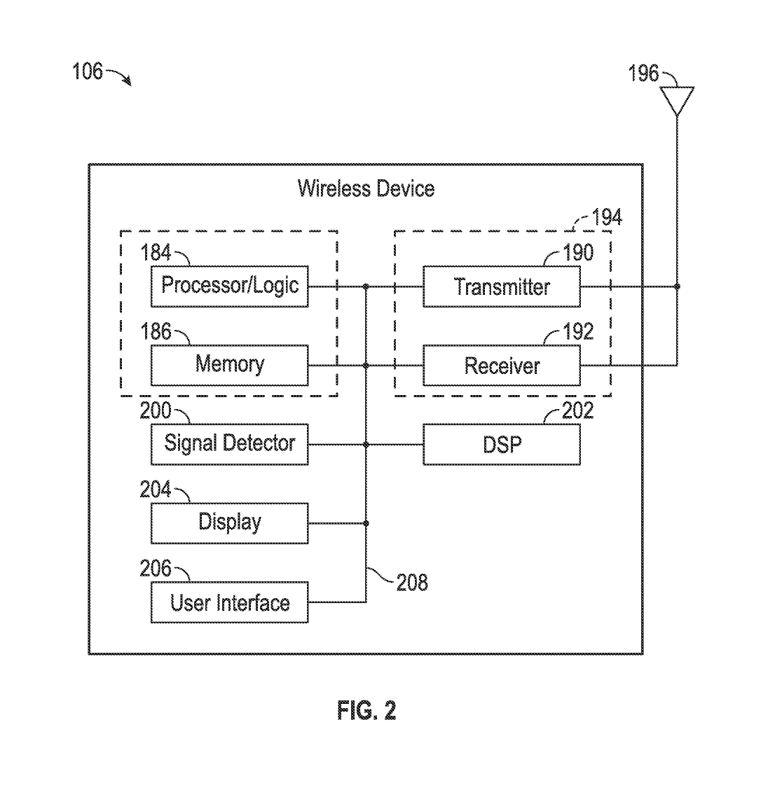

Before turning to the wireless communication methods in more detail, example wireless communication device hardware will be described with reference to FIG. 2. FIG. 2 illustrates various components that may be utilized in a wireless device 106 that may be employed within the wireless communication system described above. Although FIG. 2 is focused on the mobile device 106 of FIG. 1, similar processing components may be provided in the transmitter/receiver 102 or any other device in a wireless communication system. The wireless devices 106 and 102 are merely examples of devices that may be configured to implement the various methods described herein.

The wireless device 106 may include a processor 184 which controls operation of the wireless device 106. The processor 184 may also be referred to as a central processing unit (CPU). Memory 186, which may include both read-only memory (ROM) and random access memory (RAM), provides instructions and data to the processor 184. A portion of the memory 186 may also include non-volatile random access memory (NVRAM). The processor 184 typically performs logical and arithmetic operations based on program instructions stored within the memory 186. The instructions in the memory 186 may be executable to implement the methods described herein. The processor 184 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 106 may also include a transmitter 190 and a receiver 192 to allow transmission and reception of data between the wireless device 106 and other wireless communication devices. The transmitter 190 and receiver 192 may be combined into a transceiver 194. An antenna 196 may be provided and electrically coupled to the transceiver 194. The wireless device 180 may also include (not shown) multiple transmitters, multiple receivers, multiple transceivers, and/or multiple antennas.

The wireless device 106 may also include a signal detector 200 that may be used in an effort to detect and quantify the level of signals received by the transceiver 194. The signal detector 200 may detect such signals as total energy, energy per subcarrier per symbol, power spectral density and other signals. The wireless device 106 may also include a digital signal processor (DSP) 202 for use in processing signals. The DSP 202 may be configured to generate a data unit for transmission. The wireless device 106 may further comprise a display 204, and a user interface 206. The user interface 206 may include a touchscreen, keypad, a microphone, and/or a speaker. The user interface 206 may include any element or component that conveys information to a user of the wireless device 106 and/or receives input from the user.

The various components of the wireless device 106 may be coupled together by one or more bus systems 208. The bus systems 208 may include a data bus, for example, as well as a power bus, a control signal bus, and a status signal bus in addition to the data bus. Those of skill in the art will appreciate the components of the wireless device 106 may be coupled together or accept or provide inputs to each other using some other mechanism.

Although a number of separate components are illustrated in FIG. 2, one or more of the components may be combined or commonly implemented. For example, the processor 184 may be used to implement not only the functionality described above with respect to the processor 184, but also to implement the functionality described above with respect to the signal detector 200 and/or the DSP 202. Further, each of the components illustrated in FIG. 2 may be implemented using a plurality of separate elements. Furthermore, the processor 184 may be used to implement any of the components, modules, circuits, or the like described below, or each may be implemented using a plurality of separate elements.

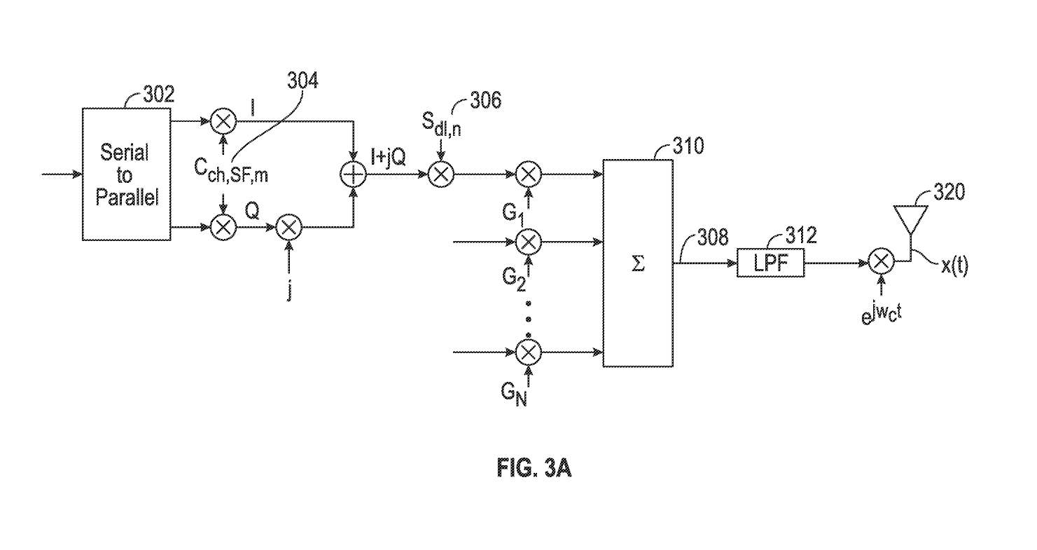

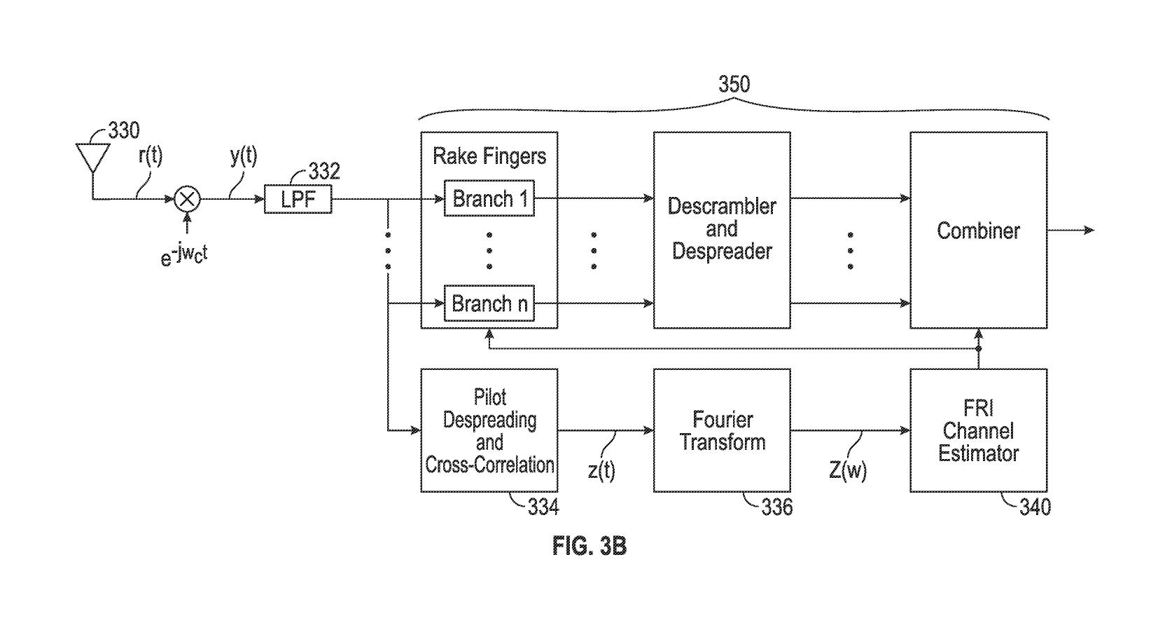

FIG. 3A is a schematic diagram of a WCDMA transmitter circuit. At block 302, consecutive pairs of symbols of +1 or −1 for a given physical channel are split between I and Q branches. The symbols on each branch are spread with a channelization code 304, the same code for each branch. The spread symbols (chips) are combined to produce a series of complex valued chips that are scrambled with a complex valued scrambling code 306. The scrambled complex chip output from each physical channel is then separately weighted, and the chips are summed at block 310 by complex addition into a single output of complex valued chips. Although shown in FIG. 3A as a single path at 308, the real and imaginary parts of the output of block 310 are split, converted to analog signals, filtered with a root raised cosine filter 312, and up-converted to the carrier frequency ωₑ for transmission by one or more antennas 320. In a WCDMA system, one of the physical channels is the common pilot channel CPICH, which is spread at 304 with a 256 spreading factor Hadamard sequence of all ones. The transmitted signal x(t) at the antenna 320 will be the summed complex chip output pₙ at 308 convolved with the filter 312 impulse response (with the impulse response of the root raised-cosine filter 312 denoted as function g) and up-converted:

$$x ( t ) = Re \{ {\sum }_{n} {p}_{n} g ( t - nT ) {e}^{j {ω}_{c} t} \}$$

This transmitted signal is then sent to the receiver over a sparse channel. For a sparse channel, the channel impulse response can be modeled as a sum of K Dirac functions, one for each path of the channel, each with a complex weight cₖ and a tap position tₖ as follows:

$$h ( t ) = {\sum }_{k = 1}^{K} {c}_{k} δ ( t - {t}_{k} )$$

Referring now to FIG. 3B, which shows a block diagram of a receiver, the received signal at antenna(s) 330 is:

$$\begin{matrix}r ( t ) = x ( t ) * h ( t ) \\ = {\sum }_{k = 1}^{K} {c}_{k} Re \{ {\sum }_{n ∈ N} {p}_{n} g ( t - {t}_{k} - nT ) {e}^{j {ω}_{c} ( t - {t}_{k} )} \}\end{matrix}$$

The received signal is down-converted with a frequency offset Δω_{c}:

$$y ( t ) = {\sum }_{k = 1}^{K} {c}_{k} {\sum }_{n ∈ N} {p}_{n} g ( t - {t}_{k} - nT ) {e}^{- j ( Δ {ω}_{c} t + {ω}_{c} {t}_{k} )}$$

This down-converted signal is filtered with a root raised cosine filter 332 in the receiver. The filtered output is processed by a rake receiver 350 for decoding. The filtered output is also processed at block 334, where pilot dispreading and cross-correlation are performed. The module 334 despreads the signal with the all one Hadamard encoding sequence and determines the cross correlation between the received pilot signal and the known pilot signal to produce a composite signal. The despreading and cross-correlation sequence is:

$${p}_{T} ( t ) = {\sum }_{n} {p}_{n}^{*} δ ( t - nT )$$

The cross-correlation is a matched filter corresponding to a convolution of the filtered signal with a negative time version of the depsreading and cross correlation sequence:

$$\begin{matrix}z ( t ) = {y}_{c} ( t ) * {p}_{T} ( - t ) \\ = {\sum }_{k = 1}^{K} {c}_{k} {e}^{- j {ω}_{c} {t}_{k}} {e}^{- j Δ ω t} {\sum }_{𝓁} {A}_{p} ( 𝓁 ) r cos ( t - {t}_{k} - 𝓁 T )\end{matrix}$$

Where Aₚ(l) is the autocorrelation sequence:

$${A}_{p} ( 𝓁 ) = {\sum }_{n} {p}_{n} {p}_{n + 𝓁}^{*} {e}^{- j Δ ω ( n + 𝓁 ) T}$$

And where r cos( ) represents the raised cosine impulse response.

Assuming no frequency offset on the down-conversion and taking all the autocorrelation terms to be noise except the zero lag term, the output of the pilot dispreading and correlation module 334 is:

$$z ( t ) = {\sum }_{k = 1}^{K} {A}_{p} ( 0 ) {c}_{k} {e}^{- j {ω}_{c} {t}_{k}} r cos ( t - {t}_{k} ) + {n}_{tot} ( t )$$

Wherein function r cos is the raised cosine impulse response function, cₖ and tₖ are the channel amplitudes and tap positions respectively, and nₜₒₜ is the crosstalk pulse interference and noise.

The inventors have observed that a frequency-domain representation of such a correlation output comprises a sum of exponentials with unknown envelopes and phases.

$$z ( ω ) = \int z ( t ) {e}^{- j ω t} d t = {\sum }_{k = 1}^{K} {A}_{p} ( 0 ) {c}_{k} {e}^{- j {ω}_{c} {t}_{k}} {e}^{- j ω {t}_{k}} R COS ( ω )$$

Where RCOS( ) is the raised cosine frequency response.

The envelopes and phases of these exponentials indicate amplitudes and tap positions (or delays) of a channel impulse response (CIR) of a sparse wireless channel. It will be appreciated that although the above mathematical analysis is presented in the continuous time domain, A/D conversion will be performed in the receiver and the dispreading/cross correlation and Fourier Transform will be performed in the digital domain according to well known digital processing techniques. The frequency response of the raised cosine function is flat within the passband, and the discrete Fourier Transform output of module 336 can be expressed as follows:

$$F ( m ) = {\sum }_{k = 0}^{K - 1} {d}_{k} {u}_{k}^{m} where {u}_{k} = {e}^{- i ( 2 π {t}_{k} / τ )}$$

Because the output of the Fourier Transform module 336 has this form, finite rate of innovation (FM) signal processing may be used to derive the amplitudes and tap positions of the channel impulse response. These values can then be used to perform channel equalization on the received data signals.

FRI signal processing is a method of analyzing signals with a “finite rate of innovation.” One such class of signals are signals made up of a series of relatively narrow pulses. For a wireless communication system, more particularly, a CDMA communication system, a FRI signal processing method may be used for estimating one or more CIR parameters of a wireless channel, such as amplitudes, delays and/or a rank of the wireless channel.

Several mathematical techniques for FRI signal processing are well known. A description of one such method applied to signals comprising a series of narrow pulses is described in Vetterli, et al., Sampling Signals With Finite Rate of Innovation, IEEE Transactions On Signal Processing, Vol. 50, No. 6 (June 2002).

Generally, FRI signal processing when applied to a signal that is made up of a series of relatively narrow and separated pulses includes low pass filtering the signal, sampling and digitizing the filtered signal with an A/D converter, and Fourier transforming the output of the A/D converter to produce a set of frequency domain Fourier coefficients. When the original signal is a series of narrow pulses, the Fourier coefficients will define a functional form of a series of sinusoids, each defined by a position and amplitude of one of the pulses of the series. Finding the positions and amplitudes of the pulses thus reduces to the problem of extracting separately the amplitudes and phases of the sinusoids that are buried in the sum that the Fourier coefficients follow. In this application of FRI signal processing, a set of the Fourier coefficients are used as an input for mathematical techniques that extract the separate phases and amplitudes of this series of sinusoids, which in turn indicate the positions and amplitudes of the pulses in the original signal.

To implement an FRI signal processing method in the receiver of FIG. 3B, the output of the correlation module 334 is Fourier transformed by Fourier transform module 336. The Fourier coefficients output from this Fourier transform function will follow a functional form of a series of sinusoids defined by parameters tₖ, the channel tap timing locations, and cₖ, the channel tap amplitudes. FRI processing to derive the channel tap positions and amplitudes is then performed at block 340 on the Fourier coefficients output by the Fourier transform module. The derived parameters may then be used to configure the rake fingers and combiner of the rake receiver 350 in accordance with the channel parameters from module 340. Although a variety of methods have been utilized to derive channel parameters for a sparse channel for channel equalization, the frequency domain analysis described herein has been found to have an excellent combination of speed, accuracy, and computational complexity.

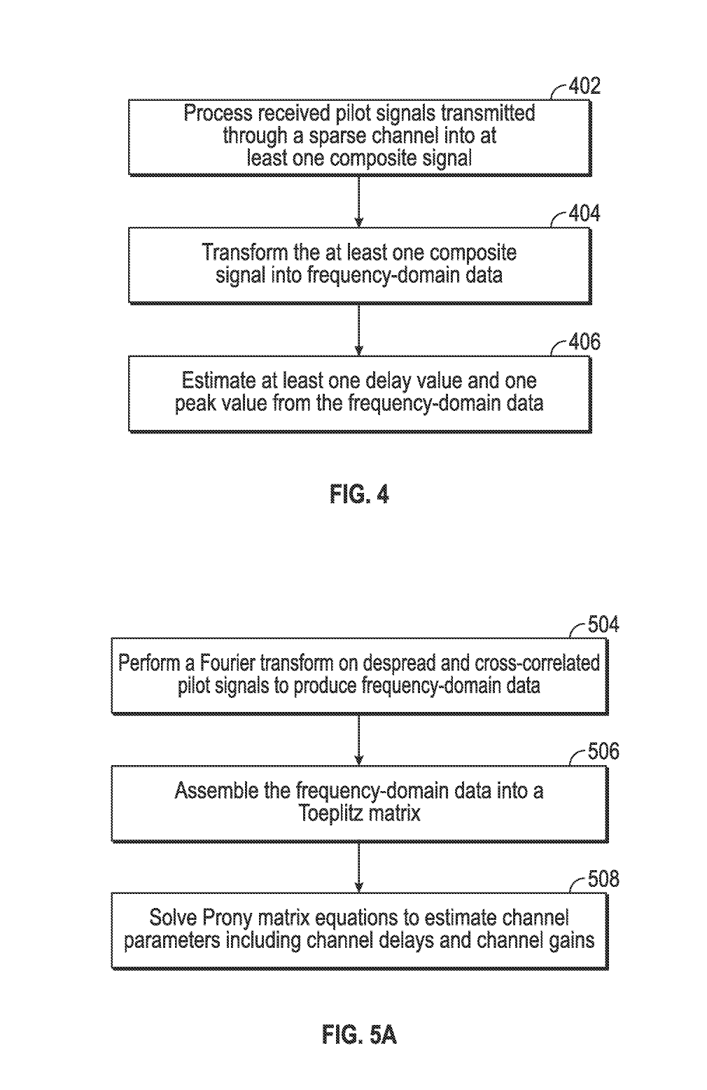

FIG. 4 is a flowchart of a method that may be performed by a receiver in accordance with one implementation. The method begins at block 402, where received pilot signals from a sparse channel are processed by despreading and cross-correlating with the known pilot sequence into a composite signal. At block 404, the composite signal is transformed into frequency domain data. At block 406, at least one delay value and one peak amplitude value are estimated from the frequency domain data. In some implementations, the delay values are derived first directly from the frequency domain data, and then the amplitudes can be derived in either the frequency or time domain.

A variety of mathematical techniques can be used to extract the amplitudes and phases of the sinusoids from the frequency domain data to implement the method illustrated in FIG. 4. One method, referred to herein as the Prony method, finds the roots of a filter that produces zero when convolved with the frequency domain data (an annihilating filter). Each root corresponds to a delay value, and from them the delay values themselves are easily derived. Once the delay values are derived, the amplitudes can be derived by solving a linear system of equations. This method is well known, and is described in Vetterli, et al., Sampling Signals With Finite Rate of Innovation, IEEE Transactions On Signal Processing, Vol. 50, No. 6 (June 2002) referred to also above.

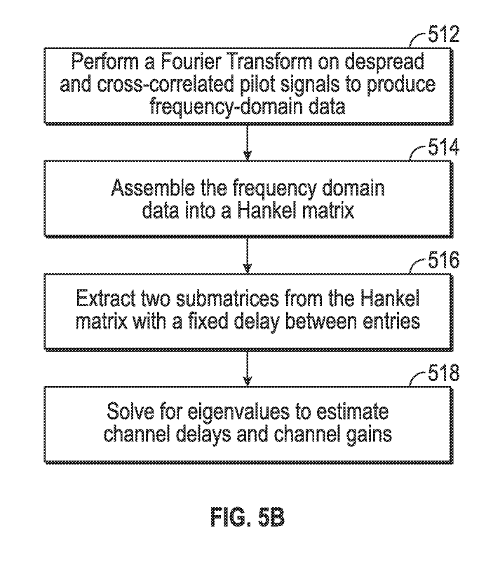

FIGS. 5 through 8 are flowcharts describing a variety of alternative mathematical methods that may be used to process the frequency domain data from the Fourier transform module of FIG. 3B.

FIG. 5A illustrates a general Prony approach. In FIG. 5, at block 504, a Fourier transform is performed on despread and cross correlated pilots signals to generate frequency domain data. At block 506, the frequency domain data points F(m) may be assembled into a Toeplitz matrix (entries along each diagonal are equal). At block 508, channel parameters including channel tap delays and gains are estimated from the Toeplitz matrix. The estimation of block 508 may be performed as follows. The Toeplitz matrix may be used in a matrix equation (e.g. a first Prony matrix equation) that is solved to find the coefficients A[k] of an annihilating filter:

$$[ \begin{matrix}F [ 0 ] & F [ - 1 ] & … & F [ - K ] \\ F [ 1 ] & F [ 0 ] & … & F [ - ( K - 1 ) ] \\ ⋮ & ⋮ & ⋱ & \\ F [ K ] & F [ K - 1 ] & … & F [ 0 ]\end{matrix} ] \cdot ( \begin{matrix}A [ 0 ] \\ A [ 1 ] \\ ⋮ \\ A [ K ]\end{matrix} ) = 0.$$

These filter coefficients (sometimes referred to herein as Prony values) define a polynomial (sometimes referred to herein as as a Prony polynomial):

$${\sum }_{𝓁 = 0}^{K} A [ 𝓁 ] {z}^{- 𝓁} .$$

The roots of this polynomial (sometines referred to herein as Prony roots) are the values uₖ from which the delays tₖ can be found. Once the values for uₖ are known, linear algebra can be used to perform a least squares fit using a second matrix equation (e.g. a second Prony matrix equation):

$$[ \begin{matrix}1 & 1 & … & 1 \\ {u}_{0} & {u}_{1} & … & {u}_{K - 1} \\ ⋮ & ⋮ & … & ⋮ \\ {u}_{0}^{( K - 1 )} & {u}_{1}^{( K - 1 )} & … & {u}_{K - 1}^{( K - 1 )}\end{matrix} ] \cdot ( \begin{matrix}{d}_{0} \\ {d}_{1} \\ ⋮ \\ {d}_{K - 1}\end{matrix} ) = ( \begin{matrix}F [ 0 ] \\ F [ 1 ] \\ ⋮ \\ F [ K - 1 ]\end{matrix} )$$

FIG. 5B is another method of deriving the delays and gains. As with the method of FIG. 5A, at block 512, frequency domain data is produced from despread and cross correlated pilot signals. At block 514, frequency domain data is assembled into a Hankel matrix (entries along anti-diagonals are equal) such as below for example:

$$F = {[ \begin{matrix}F ( 0 ) & F ( 1 ) & … & F ( L ) \\ F ( 1 ) & F ( 2 ) & … & F ( L + 1 ) \\ ⋮ & ⋮ & ⋱ & ⋮ \\ F ( N - L - 1 ) & F ( N - L ) & … & F ( N - 1 )\end{matrix} ]}_{( N - L ) \times ( L + 1 )}$$

In the presence of noise, L will be greater than K, and N will be greater than 2K. L may be referred to as the overfit parameter. In some suitable embodiments, N is selected to be 2L+1, making the above matrix F square.

At block 516, two submatrices with fixed delay between entries are extracted from the above matrix F:

$${F}_{1} = {[ \begin{matrix}F ( 0 ) & F ( 1 ) & … & F ( L - 1 ) \\ F ( 1 ) & F ( 2 ) & … & F ( L ) \\ ⋮ & ⋮ & ⋱ & ⋮ \\ F ( N - L - 1 ) & F ( N - L ) & … & F ( N - 2 )\end{matrix} ]}_{( N - L ) \times L}$$

$${F}_{2} = {[ \begin{matrix}F ( 1 ) & F ( 2 ) & … & F ( L ) \\ F ( 2 ) & F ( 3 ) & … & F ( L + 1 ) \\ ⋮ & ⋮ & ⋱ & ⋮ \\ F ( N - L ) & F ( N - L + 1 ) & … & F ( N - 1 )\end{matrix} ]}_{( N - L ) \times L}$$

It can be shown that the Prony roots (corresponding to the tap delays) are the eigenvalues of the matrix F₁^{†}F₂, where F₁^{†} indicates the pseudoinverse of F₁. Thus at block 518, eigenvalues are solved for to determine the Prony roots uₖ, from which the delays and gains can be derived as set forth above.

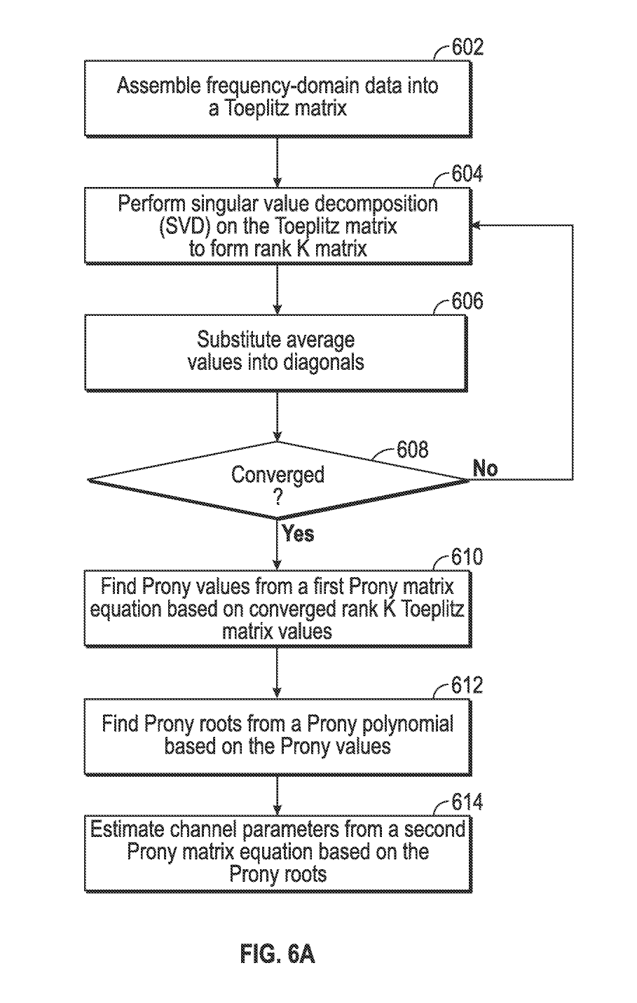

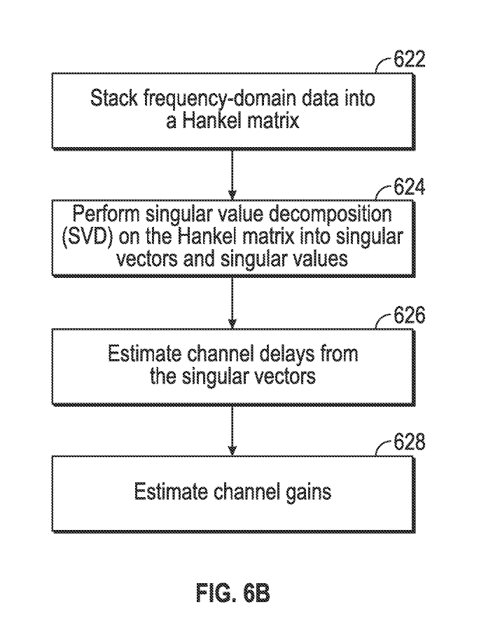

The method of FIG. 6A is one specific implementation of the method of FIG. 5A which may be used in the presence of noise in the frequency domain data. In this implementation a de-noising procedure is utilized. As in FIG. 5, at block 602 the frequency domain data from the Fourier transform of the despread and cross correlated pilot signals is assembled into a Toeplitz matrix such as:

$$F [ \begin{matrix}F ( M ) & F ( M + 1 ) & … & F ( 2 M ) \\ F ( M - 1 ) & F ( M ) & … & F ( 2 M - 1 ) \\ ⋮ & ⋱ & ⋱ & ⋮ \\ F ( 0 ) & … & F ( M - 1 ) & F ( M )\end{matrix} ]$$

With this matrix, M is at least K, and is desirably greater than K. In the presence of noise, the rank of this matrix will be greater than K. At block 604, a singular value decomposition is performed on the Toeplitz matrix to produce a reduced rank approximation of the above Toeplitz matrix having rank K. At block 606, this rank K matrix is then made Toeplitz again by replacing the each set of diagonal entries by the average along each diagonal. The system iterates between the rank K projection at block 604 and the Toeplitz projection at block 606, checking each time at decision block 608 for convergence within some determined threshold. When the denoising loop is complete, the denoised frequency domain data from the first row and column of the converged rank K matrix can be used to form a Toeplitz matrix for use in the Prony procedure as described above. at block 610 Prony values from a first Prony matrix equation based on the Toeplitz matrix are found. At block 612, Prony roots from a Prony polynomial are found. At block 614, channel parameters are estimated from a second Prony matrix equation based on the Prony roots.

The method of FIG. 6B is one specific implementation of the method of FIG. 5B which may be used in the presence of noise in the frequency domain data. In FIG. 6B, the frequency domain data is assembled into a Hankel matrix at block 622 similar to that shown above with reference to FIG. 5. At block 624, a singular value decomposition is performed on the Hankel matrix into singular vectors and singular values. At block 626, channel delays are estimated from the singular vectors. At block 628, channel gains are estimated.

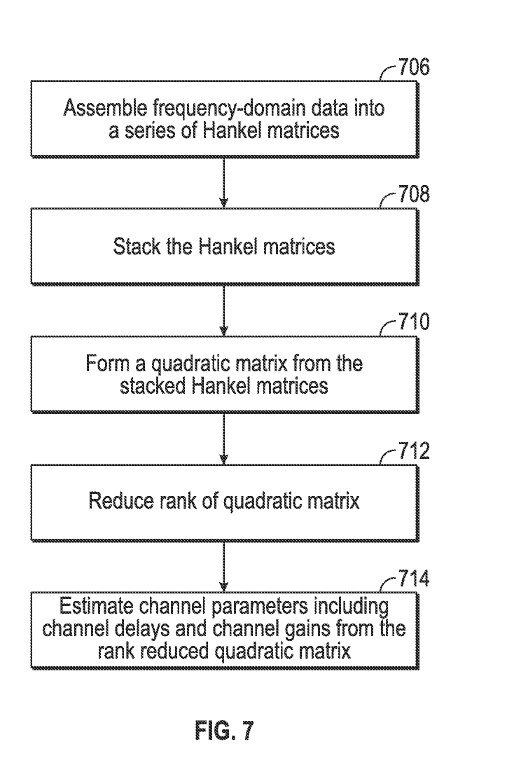

It has been noted that in actual practice, the tap delays in typical wireless channels change much slower than the channel tap gains, and thus it is possible to stack successive assembled Hankel or Toeplitz matrices and perform the above processing techniques to find the tap delays on a buffered series of matrices stacked into a single matrix. This method, however, requires memory and computation time that makes it expensive and practically difficult to implement. FIG. 7 illustrates one way to reduce this problem. In the method of FIG. 7, at block 706 the frequency domain data is assembled into a series of Hankel matrices which may be designated Y. At block 708, these matrices are stacked into a single block-Hankel matrix which may be designated H. A quadratic matrix Q=<H, H> is formed from the matrix H at block 710. At block 712, an SVD and rank reduction is performed on the matrix Q. At block 714, channel delays and channel gains are estimated from the reduced rank matrix by methods such as described above with reference to FIG. 5B for example. Because the quadratic matrix Q is smaller than H, this reduces memory requirements and increases computation speed.

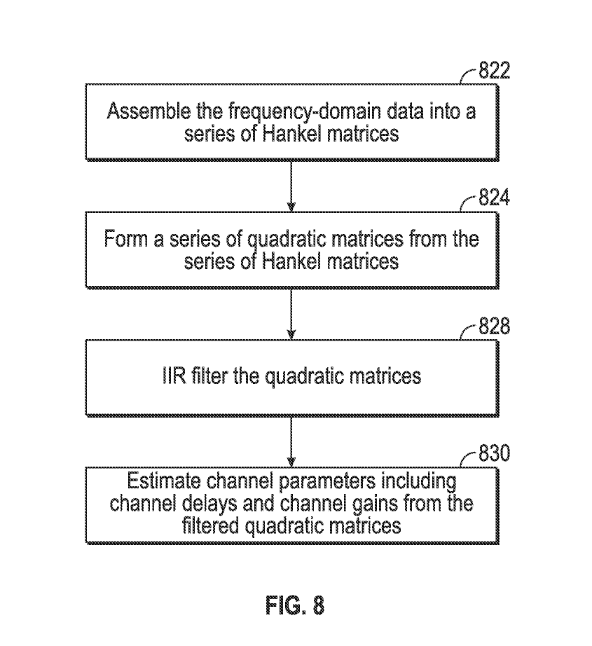

In the method of FIG. 8, memory requirements are reduced and processing speed is further improved by using an IIR filter on unstacked frequency domain matrices Y. In FIG. 8 at block 822, the frequency domain data is assembled into a series of Hankel matrices Y. A series of quadratic matrices Q=<Y,Y> are formed from the successive Hankel matrices at block 824. At block 828, the series of quadratic matrices is filtered with an IIR filter into a filtered quadratic matrix. For example, for each new Hankel matrix Y with frequency domain data that is accumulated during channel estimation:

Qₒᵤₜ→(1−a)Qₒᵤₜ+(a)<Y,Y>

The parameter a above can be adjusted based on the channel characteristics with smaller a for slower varying channels. An SVD and rank reduction on Qₒᵤₜ can be performed as above, and at block 830, channel delays and channel gains are estimated from the filtered quadratic matrix Qₒᵤₜ using methods such as described with reference to FIG. 5 for example. With this method, the slow variation in channel delays can be taken advantage of for improved noise performance, but processing matrix comprising a stack of successive Y matrices is avoided, thus reducing necessary memory and improving processing speed.

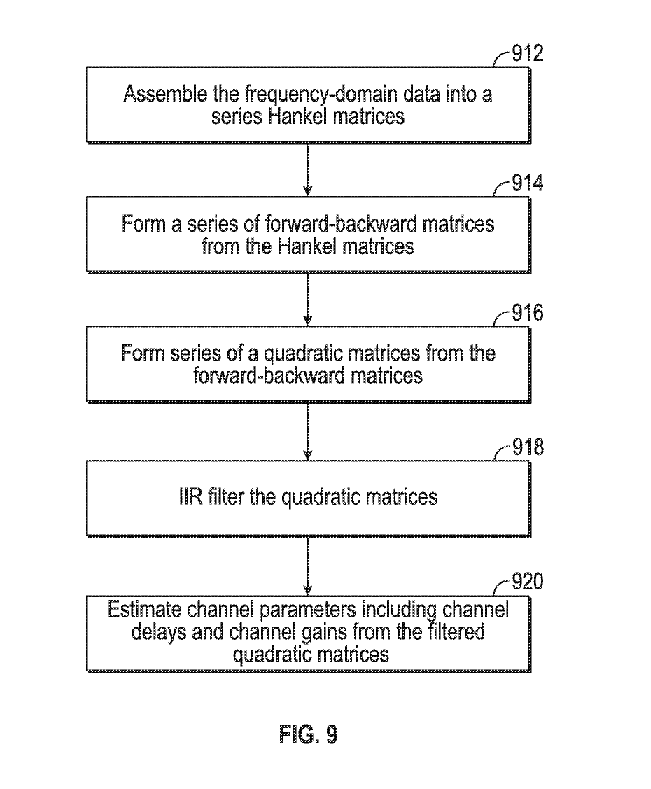

The method of FIG. 9 also begins with frequency domain data assembled into a series of Hankel matrices Y at block 912. At block 914, a series of forward-backward matrices Y_{ft}, are formed from the series of Hankel matrixes. The forward backward matrices may be defined as follows:

Y_{fb}=[Y; conj(Y*J)]

In the above equation, J is the antidiagonal matrix, and conj indicates replacing the entries with complex conjugates. The Y*J operation creates a right-left mirror image of Y. For Y_{fb}, the entries correspond to frequency indices changing in one direction for the left columns, and the other direction for the right columns.

The Y_{fb} matrix can be processed in the same manner as the matrix Y in FIG. 8. Thus, a series of quadratic matrices are formed from the series of forward-backward matrices Y_{fb} at block 916. At block 918 the series of quadratic matrices may be filtered with the same IIR filter as described above with reference to FIG. 8. At block 920, channel delays and channel gains are estimated from the filtered quadratic matrices as described above.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. An apparatus for wireless communication, the apparatus comprising:
an antenna for receiving wireless signals;
signal processing circuitry configured to:
process received pilot signals transmitted through a wireless channel to produce at least one composite signal;
Fourier transform the at least one composite signal into frequency-domain data; and
estimate at least one delay value of the wireless channel from the frequency-domain data.

2. The apparatus of claim 1, wherein the signal processing circuitry is configured to low pass filter the composite signal.

3. The apparatus of claim 1, wherein the composite signal is formed at least in part by correlating the received pilot signals and known pilot signals stored in the apparatus.

4. The apparatus of claim 1, wherein the signal processing circuitry is configured to estimate at least one delay value from the frequency domain data using finite-rate-of-innovation signal processing.

5. A method of equalizing received signals, the method comprising:
processing received pilot signals transmitted through a wireless channel into at least one composite signal;
transforming the at least one composite signal into frequency-domain data; and
estimating at least one delay value from the frequency-domain data.

6. The method of claim 5, comprising low pass filtering the composite signal.

7. The method of claim 5, comprising correlating the received pilot signals and known pilot signals stored in the apparatus to produce the composite signal.

8. The method of claim 5, wherein estimating at least one delay value from the frequency domain data comprises finite-rate-of-innovation signal processing.

9. The method of claim 8, comprising:
assembling the frequency-domain data into a series of matrices; and
performing an infinite impulse response (IIR) filtering on the series of matrices; and
estimating the at least one delay value from the output of the filtering.

10. The method of claim 8, wherein estimating the at least one delay value comprises:
assembling the frequency-domain data into a Toeplitz or Hankel matrix; and
estimating the at least one delay value from the Toeplitz or Hankel matrix.

11. The method of claim 10, wherein estimating the at least one delay value further comprises performing a singular value decomposition (SVD) on the Toeplitz or Hankel matrix or a matrix derived therefrom.

12. The method of claim 8, comprising:
generating a first Prony matrix equation from a Toeplitz matrix;
calculating Prony values from the first Prony matrix equation;
generating a Prony polynomial from the Pony values;
calculating Prony roots from the Prony polynomial;
generating a second Prony matrix equation from the Prony roots; and
estimating the at least one delay value from the second Prony matrix equation.

13. The method of claim 10, wherein estimating the at least one delay value comprises:
forming at least one quadratic matrix from the at least one Toeplitz or Hankel matrix;
processing the at least one quadratic matrix into at least one filtered quadratic matrix; and
estimating the at least one delay value from the at least one filtered quadratic matrix.

14. The method of claim 13, wherein forming the at least one quadratic matrix comprises:
stacking matrices into at least one stacked matrix; and
forming at least one quadratic matrix from the at least one stacked matrix.

15. The method of claim 13, wherein forming the at least one quadratic matrix comprises:
forming a forward-backward matrix; and
forming at least one quadratic matrix from the forward-backward matrix.

16. An apparatus for equalizing received signals, the apparatus comprising:
means for wirelessly receiving signals;
means for processing received pilot signals transmitted through a wireless channel into at least one composite signal; and
means for estimating at least one delay value from the composite signal.

17. The apparatus of claim 16, wherein the means for estimating at least one delay value from the composite signal comprises means for finite-rate-of-innovation signal processing.

18. A non-transient computer readable media having instructions stored thereon that cause a wireless communication apparatus to perform the method of:
processing received pilot signals transmitted through a wireless channel into at least one composite signal;
transforming the at least one composite signal into frequency-domain data; and
estimating at least one delay value from the frequency-domain data.

19. The non-transient computer readable media of claim 18, wherein the method comprises correlating the received pilot signals and known pilot signals stored in the apparatus to produce the composite signal.

20. The non-transient computer readable media of claim 18, wherein the estimating at least one delay value from the frequency domain data comprises finite-rate-of-innovation signal processing.
